(19) United States
(12) Patent Application Publication
(10) Pub. No.: US 2006/0070100 A1
(43) Pub. Date: Mar. 30, 2006

(54) Broadcasting reception system and method for indicating time

(75) Inventor: Shigero Kamise, Saitama-ken (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/234,123

(22) Filed: Sep. 26, 2005

(30) Foreign Application Priority Data
Sep. 27, 2004 (JP) 2004-280007

(51) Int. Cl. H04N 5/445; G06F 13/00; G06F 3/00

(52) U.S. Cl. 725/58

(57) ABSTRACT

A digital television broadcasting reception device contained in a broadcasting reception system has a function for receiving selectively digital broadcasting by means of antennas and tuners, and a function for connecting external instruments through a variety of interfaces. A control section controls the whole system. A timer section of an automatically acting type sets up a time based on time information contained in digital broadcasting, besides a time can be obtained also from Internet through a communication I/F, or time information obtained by a manual operation of a user with a remote controller in the case when digital broadcasting cannot be received.

The present application is based on Japanese patent application No. 2004-280007, the entire contents of which are incorporated herein by reference.

### BACKGROUND OF THE INVENTION

1. Field of the Invention

The present invention relates to a broadcasting reception system for receiving digital television broadcasting and the like, and particularly to a broadcasting reception system and a method for indicating a time wherein a time can be set up in a built-in timer by a user in a case where no time information is even obtained from the outside of the broadcasting reception system.

2. Description of the Related Art

Heretofore, a broadcasting reception device such as a television receiver substantially all the models of which contains a timer function, a sleep function and the like in addition to a function for simply receiving broadcasting with progress of semiconductor technology. To realize these functions, a broadcasting reception device is provided with a time circuit using a quartz resonator, or a circuit for setting up a time based on time information contained in a transmission signal received.

A time device for setting up a time based on time information received is disclosed, for example, in Japanese patent application laid-open No. Hei 7-12963 (see paragraphs [0014], [0021], and [0022] to [0028], FIG. 1 and FIG. 2). The time device disclosed receives broadcasting signals containing time information to separate time data from complex video signals by a time signal decoder, and a control microcomputer sets up a time in a timer based on the time data separated, besides the time thus set up is updated in each predetermined period of time.

As a result, electronic equipment having a built-in timer wherein a correct time is constantly established by turning simply on its power supply, so that a leading end of a television program which is intended to record in a storage medium in accordance with a timer recording and the like is never cut off can be obtained.

According to a conventional broadcasting reception device, however, when a reception condition is poor, or when the broadcasting reception device is not connected to a signal source, time information cannot be taken into the broadcasting reception device, so that any time information cannot be set up in the timer. In addition, a user cannot confirm a present set-up condition in the timer.

Accordingly, an object of the present invention is to provide a broadcasting reception system and a method for indicating a time wherein a time can be set up by a user in a built-in timer even in a case where no time information is obtained from the outside of the broadcasting reception system.

### SUMMARY OF THE INVENTION

According to the present invention, a broadcasting reception system may comprise a self-acting timer section in which a time can be arbitrarily set up; a time information input section to which time information is supplied from the outside of the broadcasting reception system; and a control section allowing to display a message to induce inputting of time information by a user when the time information cannot be received from the time information input section.

According to the present invention, a broadcasting reception system may comprise a self-acting timer section to arbitrarily set up a time; a time information input section for receiving time information from an outside of a broadcasting reception system; and a control section for controlling a display to indicate a message for a user to induce an inputting of a time information.

The control section may allow the timer section to input the time information thereto in accordance with operation by a user, when the time information is not received from the outside of the broadcasting reception system.

The time information input section may include a plurality of systems to which time information is supplied, and determines an order of precedence in accordance with an order of reliability in the time information supplied from the plurality of systems to select them.

The plurality of systems may include digital broadcasting and Internet.

The timer section may be backed up by a backup power supply.

The backup power supply may be an electric double layer capacitor.

The time information input section may be supplied with time information from digital broadcasting, and the control section may indicate a time based on the time information obtained by the time information input section in case of receiving analog broadcasting.

The timer section may be a crystal-oscillator circuit, or a frequency divider.

The backup power supply may be a secondary cell, or a microcell.

According to the present invention, a method for indicating a time may comprise a step for receiving a transmission signal containing time information; and a step for updating time information in a timer section based on the time information contained in the transmission signal received, while displaying a message to induce inputting of time information by a user when the transmission signal containing time information is not received.

The step for updating time information may include a step for establishing an operation mode allowing to update the time information in the timer section by means of an operation by a user when the transmission signal containing time information is not received.

The step for receiving a transmission signal may include a step for receiving satellite digital television broadcasting containing the time information as the transmission signal.

The step for receiving a transmission signal may include a step for obtaining the time information from a plurality of transmission sources each of which transmits the time information being the newest time information in accordance with a predetermined order of precedence.

The predetermined order of precedence may be an order of digital broadcasting, a network, and an operation by a user.

### BRIEF DESCRIPTION OF THE DRAWINGS

The present invention will be explained in more detail in conjunction with appended drawings, wherein:

FIG. 1 is a block diagram showing a whole constitution of a broadcasting reception system according to a first embodiment of the present invention;

FIG. 2 is a block diagram showing a detailed constitution of a digital television broadcasting reception device of FIG. 1;

FIG. 3 is a flowchart showing processing for updating time information in a timer section of FIG. 1;

FIG. 4 is a diagram showing a display screen page in a step S109 of FIG. 3; and

FIG. 5 is a flowchart showing processing for updating time information of a broadcasting reception system according to the second embodiment of the present invention.

### DESCRIPTION OF THE PREFERRED EMBODIMENTS

A preferred embodiment of the present invention will be described in detail hereinafter.

### First Embodiment

(Constitution of Broadcasting Reception System)

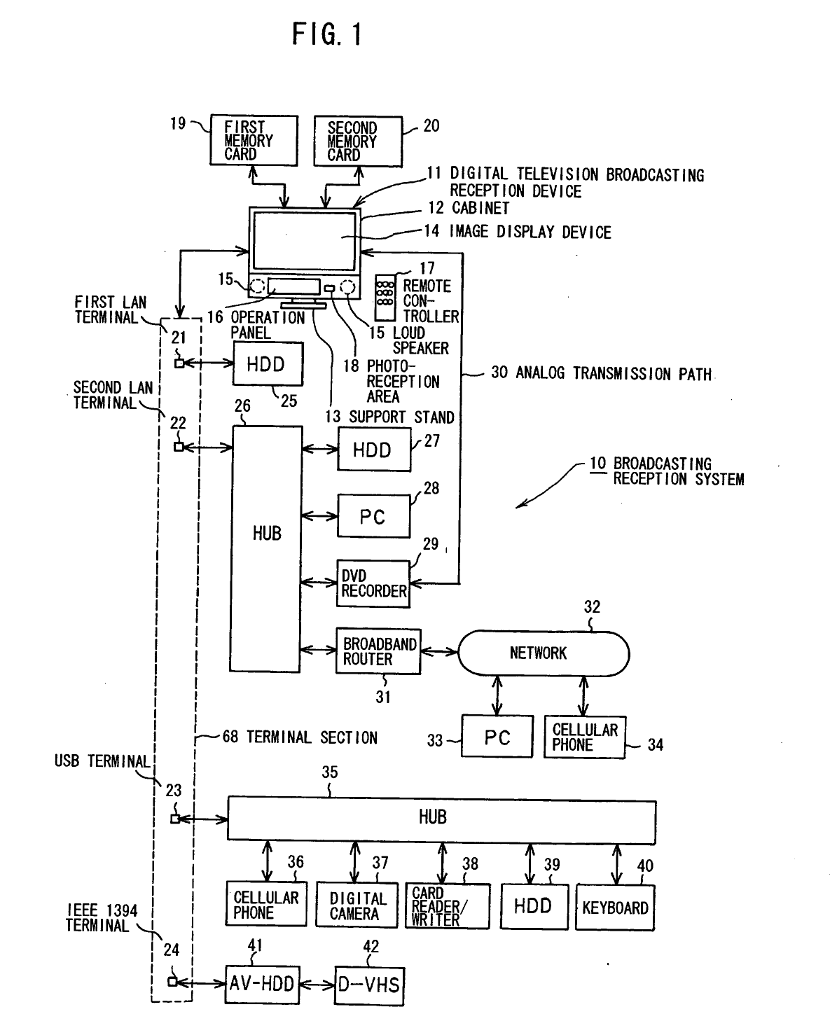

FIG. 1 is a block diagram showing a whole constitution of a broadcasting reception system according to the first embodiment of the present invention wherein the broadcasting reception system 10 is principally composed of a digital television broadcasting reception device 11.

The broadcasting reception system 10 is provided with the digital television broadcasting reception device 11, first and second memory cards 19 and 20 fitted detachably to the digital television reception device 11, a first LAN (Local Area Network) terminal 21, a second LAN terminal 22, a USB (Universal Serial Bus) terminal 23, an IEEE (Institute of Electrical and Electronics Engineers) 1394 terminal 24, a HDD (Hard Disc Drive) 25 connected to the first LAN terminal 21, a HDD 27, a PC (Personal Computer) 28, a hub 26 to which a broadband router 31 is connected together with the second LAN terminal 22, a DVD (Digital Versatile Disk) recorder 29 with built-in HDD which is connected to the hub 26 and connected also to the digital television broadcasting reception device 11 through an analog transmission path 30, and a hub 35 connected to the USB terminal 23. The first LAN terminal 21, the second LAN terminal 22, the USB terminal 23, and the IEEE 1394 terminal 24 are gathered into an area as a terminal section 68.

The digital television broadcasting reception device 11 has a cabinet 12 molded from a resin material, and a support stand 13 for supporting the cabinet 12. The cabinet 12 contains an image display device 14 of a flat panel type, for example, an LCD (Liquid Crystal Display) panel, loud speakers 15, an operation panel 16, and a photoreception area 18 for receiving operation information transmitted from a remote controller 17.

The first memory card 19 may be, for example, an SD (Secure Digital) memory card, an MMC (Multimedia Card), Memory Stick (registered trademark) or the like; and which is used for recording and reproducing information as to broadcasting programs, photographs and the like. On one hand, the second memory card 20 contains, for example, information of an agreement and the like recorded previously; and which is arranged to be fitted detachably to the digital television broadcasting reception device 11.

The first LAN terminal 21 is an exclusive port used for a LAN compliant HDD; and which is applied for recording and reproducing information according to Ethernet (registered trademark) with respect to the LAN compliant HDD 25 being a connected NAS (Network Attached Storage). As a result of providing the first LAN terminal 21, such an environment that contents in hi-vision quality of a program are stably stored in the HDD 25 can be constituted without being affected adversely by the other network environments, and conditions in a network applied.

The second LAN terminal 22 is used as a general LAN compliant port according to Ethernet (registered trademark); and which is applied for transmission of information between an instrument such as the LAN compliant HDD 27, the PC 28, and the DVD recorder 29 with built-in HDD through the hub 26.

The USB terminal 23 is used for a general USB compliant port; and which is connected to a hub 35. To the hub 35, a cellular phone 36, a digital camera 37, a card reader/writer 38, a HDD 39, a keyboard 40 and the like may be connected.

To the IEEE 1394 terminal 24, an AV-HDD 41 may be connected, and further a D (Digital)-VHS (Video Home System) 42 can be connected through a serial connection with the AV-HDD 41.

A network 32 is connected to the broadband router 31 wherein a PC, and a cellular phone 34 can be connected to the network 32.

(Constitution of Digital Television Broadcasting Reception Device)

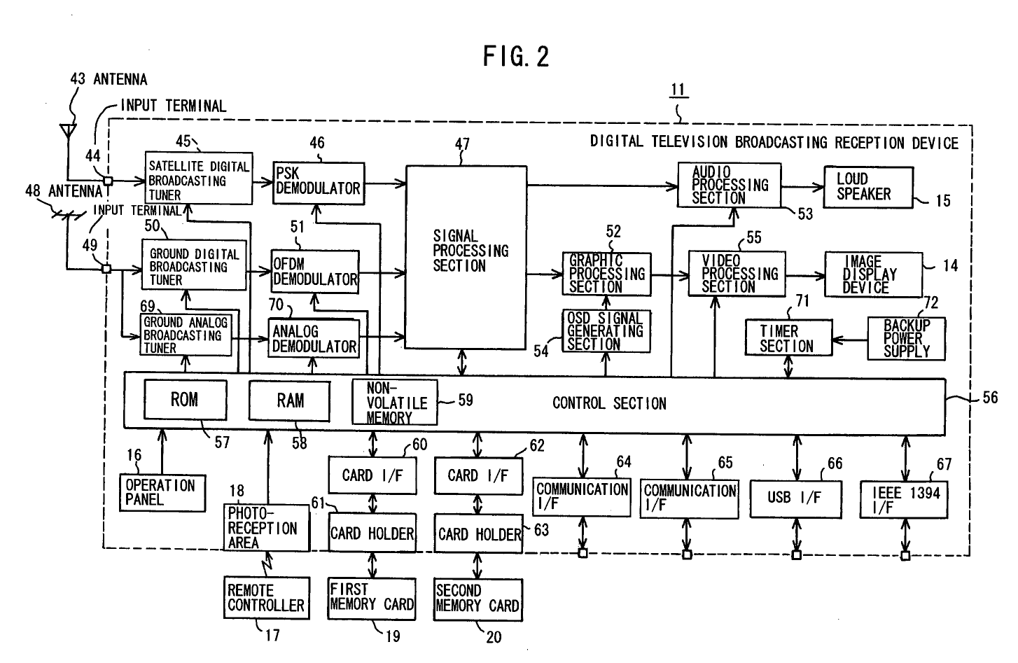

FIG. 2 is a block diagram showing a detail of the digital television broadcasting reception device 11 which is composed of an input terminal 44 connected to an antenna 43 for receiving BS (Broadcast Satellite)/CS (Communication Satellite) digital broadcasting, a tuner 45 connected to the input terminal 44, a PSK (Phase Shift Keying) demodulator 46 connected to the tuner 45, a signal processing section 47 connected to the PSK demodulator 46, an input terminal 49 connected to an antenna 48 for receiving ground digital broadcasting, a tuner 50 for receiving ground digital broadcasting, which is connected to the input terminal 49, an OFDM (Orthogonal Frequency Division Multiplexing) demodulator 51 connected to the tuner 50 and the signal processing section 47, a graphic processing section 52 connected to the signal processing section 47, an audio processing section 53 connected to the signal processing section 47, an OSD (On Screen Display) signal generating section 54 connected to the graphic processing section 52, a video processing section 55 connected to the graphic processing section 52, a CPU (not shown), a ROM (Read Only Memory) 57 storing a control program to be executed by the CPU, a RAM (Random Access Memory) 58, and a non-volatile memory 59 storing a variety of information for setting components and control information therefor. The digital television broadcasting reception device 11 is further provided with a control section 56 for controlling the whole digital television broadcasting reception device, a card I/F (Interface) 60 connected to the control section 56, a card holder 61 with which the first memory card 19 is loaded, a card I/F 62 connected to the control section 56, a card holder 63 with which the second memory card 20 is loaded, communication I/Fs 64 and 65 connected to the control section 56, respectively, a USB I/F 66 connected to the control section 56, an IEEE 13941 I/F 67 connected to the control section 56, an analog broadcasting tuner 69 connected to the input terminal 49, an analog demodulator 70 connected to the tuner 69 and the signal processing section 47, a timer section 71 connected to the control section 56, and a backup power supply 72 for supplying power to the timer section 71.

An input means for time information is composed of the tuner 45, the PSK demodulator 46, the signal processing section 47, the tuner 50, and the OFDM demodulator 51.

The antenna 43 is usually a parabolic antenna, while the antenna 48 is, for example, a Yagi antenna which is used for receiving ground waves.

The tuner 45 is used for receiving satellite digital broadcasting, and which is arranged to select a station by means of control from the control section 56 thereby to receive satellite digital television broadcasting. The PSK demodulator 46 functions to demodulate satellite digital television broadcasting to digital video signals and digital audio signals.

The tuner 50 is used for receiving ground digital broadcasting, and which is arranged to select a station by means of control from the control section 56 thereby to receive ground digital television broadcasting. The OFDM demodulator 51 functions to demodulate ground digital television broadcasting to digital video signals and digital audio signals.

Furthermore, the tuner 69 is a conventional one for receiving analog broadcasting, and which is arranged to select a station by means of control from the control section 56 thereby to receive analog television broadcasting. The analog demodulator 70 functions to demodulate analog television broadcasting to analog video signals and analog audio signals.

The signal processing section 47 is served for applying selectively predetermined digital signal processing to the digital video and audio signals supplied from the PSK demodulator 46 as well as the digital and audio signals supplied from the OFDM demodulator 51 to output the signals thus processed to the graphic processing section 52 and the audio processing section 53. On one hand, the signal processing section 47 is served for digitizing the signals demodulated by the analog demodulator 70 to output the results obtained to the graphic processing section 52 and the audio processing section 53, respectively.

The graphic processing section 52 is served for superposing OSD signals generated by the OSD signal generating section 54 to the digital video signals from the signal processing section 47 to output the resulting signals. Moreover, the graphic processing section 52 either outputs selectively the video signals output from the signal processing section 47 and the OSD signals output from the OSD signal generating section 54, or outputs both the signals in such that a window on a display is occupied by a half each of both screen pages output.

The audio processing section 53 functions to convert the digital audio signals delivered from the signal processing section 47 to analog audio signals which can be reproduced by the loud speakers 15, and functions also to amplify the audio signals thereby outputting the resulting signals.

The video processing section 55 is served for converting the digital video signals from the graphic processing section 52 to analog video signals formatted so as to be displayable by the image display device 14 to output the resulting signals to the image display device 14.

The control section 56 either receives operation information from the operation panel 16, or receives the operation information delivered from the remote controller 17 through the photoreception area 18, whereby control operation defined by reflecting contents of the operation is performed. Furthermore, the control section 56 exchanges information with the first memory card 19 through the card I/F 60 in the case when the first memory card 19 is loaded into the card holder 61. Likewise the control section exchanges information with the second memory card 20 in the case when the second memory card 20 is loaded into the card holder 63.

In addition, the control section 56 is served for exchanging information with the LAN compliant HDD 25 connected to the first LAN terminal 21. In this case, the control section 56 has DHCP (Dynamic Host Configuration Protocol) server function, so that the control section 56 assigns an IP (Internet Protocol) address to the LAN compliant HDD 25 connected to the first LAN terminal 21 to control the LAN compliant HDD 25. The control section 56 functions also to exchange information with each of the instruments, which is shown in FIG. 1 and connected to the second LAN terminal 22 through the hub 26, by way of the communication I/F 65. Besides, the control section 56 is served for exchanging information with each of the instruments connected to the IEEE 1394 terminal 24 through the IEEE 1394 I/F 67 in addition to a function to exchange information with each of the instruments, which is connected to the USB terminal 23 through the hub 35, by way of the USB I/F 66.

The timer section 71 contains a base clock constituted from, for example, a crystal-oscillator circuit, a frequency divider or the like, resulting in a real-time clock function for producing time information based on the base clock, and the timer section 71 has further a self-starting function by which it can operate by itself, and a function for updating externally time information. The timer section 71 is operated by a backup power supply 72 as its electric source in case of turning off the power, so that timer section 71 continues to function time keeping operation based on its own time information even when the digital television broadcasting reception device 11 is in a poweroff state.

As the backup power supply 72, for example, an electric double layer capacitor having an electrostatic capacity of around one farad may be used. The electric double layer capacitor is excellent in discharge characteristic, so that a voltage charged can be maintained for a long period of time. It is to be noted that the backup power supply 72 is not limited to such electric double layer capacitor, but an electric cell such as secondary cell, and microcell may be used.

(Whole Operation of Digital Television Broadcasting Reception Device)

In the following, operations of the digital television broadcasting reception device 11 will be described.

When a user pushes a power button (not shown) on the operation panel 16 or the remote controller 17, the electric power supply of the digital television broadcasting reception device 11 comes to be in active. In such a case where a digital television broadcasting reception device is initially installed after purchasing it, or a case where a broadcasting reception device is left to stand for a long period of time with removal of a power cord, when a power is activated and a user sets up time information with the use of the remote controller 17 or the like, the time information is stored in the RAM 58 and read out by the control section 56, whereby a setup of the timer section 71 is completed. Thereafter, the timer section 71 acts automatically to continue time keeping. In these circumstances, since the antennas 43 and 45 for receiving digital broadcasting are provided, time information can be obtained from a reception output of digital broadcasting, when its receiving condition is good.

In this situation, when the user operates the remote controller 17 to select one of BS/CS digital broadcasting, ground digital broadcasting, and analog broadcasting, the control section 56 makes one of the tuners 45, 50, and 69 corresponding to the broadcasting selected to be active. For instance, when a BS/CS digital broadcasting is selected, satellite digital television broadcasting signals received by the antenna 43 are input to the tuner 45 for satellite digital broadcasting through the input terminal 44. Further, when the user selects a desired channel, broadcasting signals in the channel selected are input to the PSK demodulator 46. The PSK demodulator 46 demodulates the broadcasting signals into digital video signals, digital data signals, and digital audio signals. Then, the signals thus demodulated are output to the signal processing section 47.

On one hand, ground digital and analog television broadcasting signals received by the antenna 48 are delivered to the tuner 50 for ground digital broadcasting and the tuner 69 for ground analog broadcasting, respectively, through the input terminal 49. Ground digital broadcasting signals selected by the tuner 50 are demodulated by the OFDM demodulator 51 into digital video signals, digital data signals, and digital audio signals, and then, the signals thus demodulated are output to the signal processing section 47.

With respect to the demodulated signals from the reception side, the signal processing section 47 applies a predetermined digital signal processing to the video signals and the audio signals in every broadcasting systems, and the signals thus processed are output to the graphic processing section 52 and the audio processing section 53, respectively. Furthermore, the signal processing section 47 extracts time information from the information contained in BS data broadcasting or ground wave data broadcasting, and the time information obtained is once stored in the RAM 58 inside the control section 56. The control section 56 reads the time information contained in the timer section 71 acting automatically, and compares a value thereof with that obtained from the time information in the data broadcasting. When the former value deviates from that obtained from the data broadcasting, the control section 56 reads out the latter value of the time information from the RAM 58, and the latter value is set up in the timer section 71.

In case of standby, since a main power supply is not cut out, it is possible to obtain always fresh time information so far as a reception is in a good condition, so that time information can be corrected in the timer section 71 in response to the time information received.

Time information cannot be obtained from a side of digital broadcasting in such a case where an electric power supply is turned off in the digital television broadcasting reception device 11, a case where a power cord is removed from the television broadcasting reception device, or a case where a reception condition of radio waves becomes poor due to rainfall, snowfall, eclipse or the like, so that an update of time is not controlled in the timer section 71. In this respect, however, an electric power is supplied to the timer section 71 from the backup power supply 72, even when the power supply is turned off, whereby the timer section 71 maintains its function. As a result, time information is updated; and when the power supply is again turned on after it is once turned off, the control section 56 reads time information from the timer section 71 and the time information obtained is delivered to the OSD signal generating section 54. The OSD signal generating section 54 converts the time information to character information, and the resulting character information is output to the graphic processing section 52. The graphic processing section 52 superimposes the characteristic information to video signals from the signal processing section 47, and further a color adjustment is made on the signals thus superimposed by the video processing section 55. The video signals thus obtained are displayed on the image display device 14 as time information.

On one hand, the digital video signals from the graphic processing section 52 are converted to analog video signals formatted by the video processing section 55 in a form which can be displayed on the image display device 14, and then, the resulting analog video signals are sent to the image display device 14. On the other hand, the audio processing section 53 converts the digital audio signals delivered from the signal processing section 47 to analog audio signals to drive the loud speakers 15. The loud speakers 15 make electricity-acoustic conversion to reproduce and output the resulting voices.

(Update Processing of Time Information)

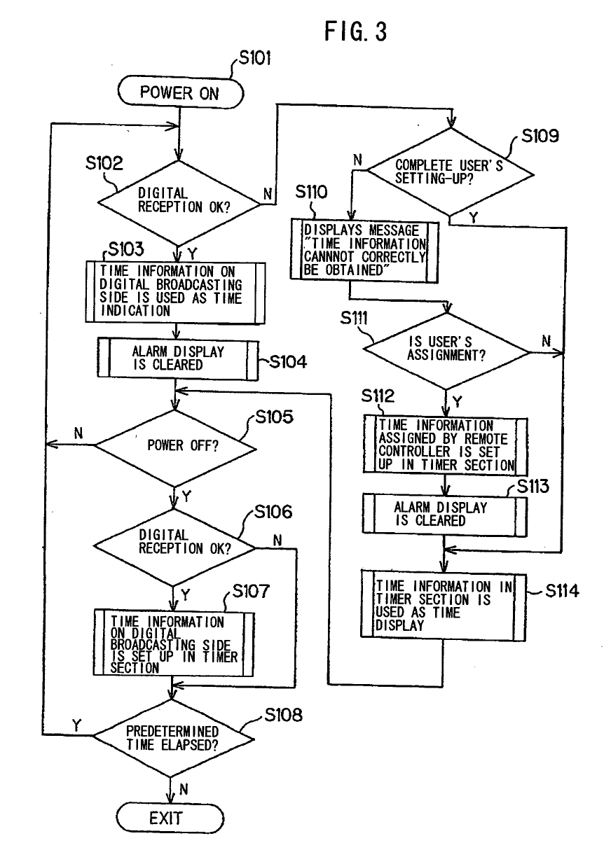

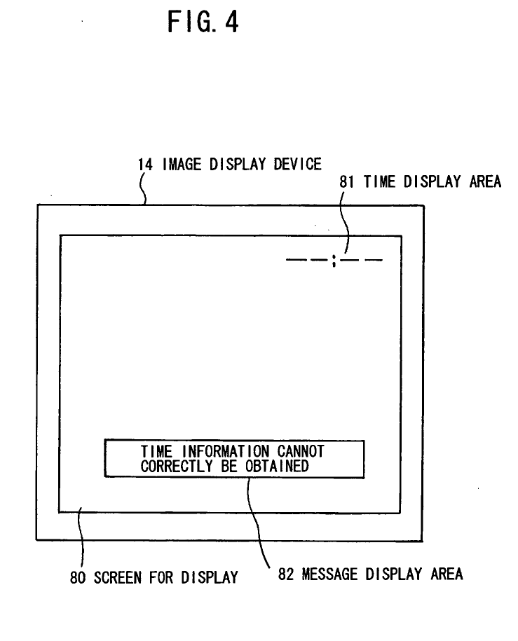

FIG. 3 is a flowchart showing update processing of timer information in the timer section 71 wherein a character S represents “step”. FIG. 4 is a displayed screen page in S109 of FIG. 3. In the following, update processing of time information in the timer section 71 will be described by referring to FIGS. 3 and 4.

First, when a power is turned on (S101) in the digital television broadcasting reception device 11, it is judged whether or not digital broadcasting can be received (S102). Accuracy in time information is better in data of digital broadcasting than that set up manually by a user. Accordingly, when digital broadcasting can be received, time information in the digital broadcasting is used for time indication (S103).

Under the circumstances, if there was an alarm display on the image display device 14 such that “time information cannot correctly be obtained”, such alarm display is cleared (S104) because of reception of time information from the digital broadcasting.

After the timer section 71 is set up based on the timer information of digital broadcasting, when the power of the digital television broadcasting reception device 11 is turned off (S105), a reception condition on a side of the digital broadcasting is again confirmed (S106), and up-to-date time information is written in the timer section 71 (S107), if the time information is effective. These processing steps S102 to S107 are performed periodically during a period of time wherein the power is turned on (S108), while until it does not reach a predetermined period of time, the work operation gets out the processing routine shown in FIG. 3, and it returns to the step S108 after the lapse of the predetermined time.

On the other hand, when digital broadcasting is not received, it is judged whether or not time information is set up by a user (S109). If such time information has not yet been set up by the user, for example, in the case when the antennas 43 and 48 for digital broadcasting reception have not yet been connected to the broadcasting reception system 10 at the time of energization, or the case where time information cannot be obtained from digital broadcasting because of a poor reception condition, the control section 56 displays a message “time information cannot correctly be obtained” on the message display area 82 as shown in FIG. 4. As a result, a situation shifts to an operation mode wherein time information can be updated by the user, and the control section 56 induces to input time information by the user. In this case, an alarm may be output through the loud speakers 15, if necessary. At this stage, the time information set up by the user becomes effective.

Thereafter, it is judged whether or not there is time information set up by the user (S111), and the time information set up by means of the remote controller 17 is established in the timer section 71 in case of existing the time information set up by the user (S112). The time information thus established is registered in the timer section 71 as an initial value.

Then, the displayed item on the message display area 82 is cleared, and at the same time, an alarm is stopped (S113). Furthermore, a present time is displayed on a time display area 81 based on the time information in the timer section 71 (S114) This processing is also executed in the case where there is a judgment “Yes” in the step S109. From this step onward, processing in steps S105 to S108 is executed.

### Advantageous Effects of the First Embodiment)

According to the first embodiment, the following advantageous effects are obtained.

(a) Even when no time information can be obtained from digital broadcasting, a present time may be manually set up by a user in the timer section 71, whereby time information can be displayed until the digital broadcasting can be correctly received.

(b) If time information cannot be obtained from digital broadcasting, then, time information is obtained from the network 32, so that a necessary case where a manual setting must be made by a user can be reduced.

(c) Either such a message that time information cannot be correctly obtained is displayed on the image display device 14, or an alarm is issued in the case where a present time must be manually set up by a user in the timer section 71. Accordingly, the user can understand a present status of the digital television broadcasting reception device 11.

(d) Even when a power of the digital television reception device 11 is turned off, the timer section 71 is backed up by the backup power supply 72, so that no time information disappears. When the power is turned on, the timer section 71 continues to operate based on the time information at the time when the power is turned off, and further the digital television reception device 11 can carry out operations on the basis of the timer section 71.

In the first embodiment, although such a constitution wherein time information is obtained from digital broadcasting, and a time indication is made based on the time information has been described, such function is effective for a user who does not watch digital television broadcasting. More specifically, when a power supply is turned on in the digital television broadcasting reception device 11, the tuners 45 and 50 come to be a state wherein digital broadcasting can be received. Accordingly, when digital broadcasting is received by either or both of the tuners 45 and 50 to obtain time information in background, a time indication can be made on the image display device 14 as time information in even a case where a user watches analog broadcasting.

### Second Embodiment

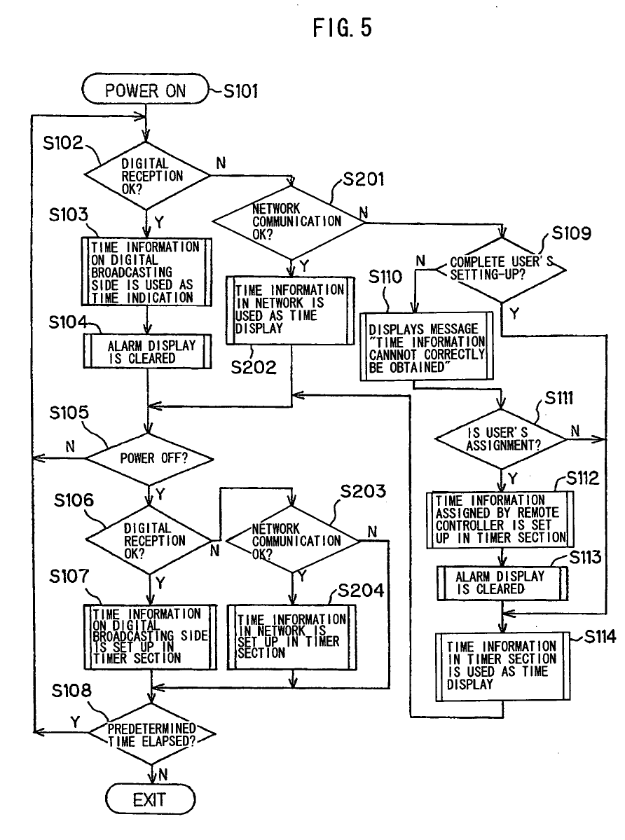

FIG. 5 is a flowchart showing processing for setting up a time in a broadcasting reception device according to the second embodiment of the present invention wherein particularly, processing for setting up a time in a timer section 71 is shown, and it is to be noted that the same step as that of FIG. 3 is designated by the same step number as that of FIG. 3, besides, the hardware constitutions are the same as those shown in FIGS. 1 and 2. Accordingly, explanation for overlapped processing and constitutions are omitted in the following description.

In a step S102, when it is judged that digital broadcasting cannot be received, a control section 56 judges whether or not a network communication is possible (S201). More specifically, time information obtained from a network 32 is utilized for a time indication (S202) in the case where a hub 26 is connected to a second LAN terminal 22, and further, the network 32 is connected to a broadband router 31. From this step onward, processing in steps S104 to S107 is executed as described in FIG. 3.

In the step S201, when it becomes clear that a network communication cannot be carried out, its processing step shifts to a step S109 wherein time information is to be manually set up by a user.

The reason why processing of the step S102 is given precedence to the step 201 as described above is in that when the number of accesses increases, an uptake rate of data from the network 32 decreases, so that there is a lack of a capability of immediate answer, while time information from digital broadcasting is more positive. Moreover, since the timer section 71 acts automatically, when time information is once set up, it is updated automatically. However, there is an error of several tens ppm. Thus, processing of the step S201 wherein time information is obtained from the network 32 is disposed to upstream of the step S109, and these steps are followed to the step 102 wherein time information is obtained from digital broadcasting.

In the step S106, when digital broadcasting is not received after the power supply is turned off, it is judged whether or not a network communication is possible (S203), if possible, a time is set up in the timer section 71 by the use of time information obtained from the network 32 (S204). Thereafter, processing of from the step S108 onward is executed.

### Advantageous Effects of the Second Embodiment

According to the second embodiment, since time information can be obtained from a side of the network 32 in addition to a procurement of time information from digital broadcasting, an opportunity wherein a time is set up without requiring any manual operation by a user can be increased in even a case where digital broadcasting cannot be received.

### The Other Embodiments

The present invention is not limited to the above-mentioned preferred embodiments, but a variety of the other modifications may be applied so far as the subject matter of the invention is not changed. For instance, the invention may have a constitution wherein there is no analog broadcasting reception system composed of the tuner 69 and the analog demodulator 70 in FIG. 2.

It will be appreciated by those of ordinary skill in the art that the present invention can be embodied in other specific forms without departing from the spirit or essential characteristics thereof.

The presently disclosed embodiments are therefore considered in all respects to be illustrative and not restrictive. The scope of the invention is indicated by the appended claims rather than the foregoing description, and all changes that come within the meaning and range of equivalents thereof are intended to be embraced therein.

What is claimed is:

1. A broadcasting reception system, comprising:
a self-acting timer section in which a time can be arbitrarily set up;
a time information input section to which time information is supplied from the outside of the broadcasting reception system; and
a control section allowing to display a message to induce inputting of time information by a user when the time infomation cannot be received from the time information input section.

2. A broadcasting reception system, comprising:
a self-acting timer section to arbitrarily set up a time;
a time information input section for receiving time information from an outside of a broadcasting reception system; and
a control section for controlling a display to indicate a message for a user to induce an inputting of a time information.

3. The broadcasting reception system as defined in claim 2, wherein:
the control section allows the timer section to input the time information thereto in accordance with operation by a user, when the time information is not received from the outside of the broadcasting reception system.

4. The broadcasting reception system as defined in claim 2, wherein:
the time information input section includes a plurality of systems to which time information is supplied, and determines an order of precedence in accordance with an order of reliability in the time information supplied from the plurality of systems to select them.

5. The broadcasting reception system as defined in claim 4, wherein:
the plurality of systems includes digital broadcasting and Internet.

6. The broadcasting reception system as defined in claim 1, wherein:
the timer section is backed up by a backup power supply.

7. The broadcasting reception system as defined in claim 2, wherein:
the timer section is backed up by a backup power supply.

8. The broadcasting reception system as defined in claim 6, wherein:
the backup power supply is an electric double layer capacitor.

9. The broadcasting reception system as defined in claim 1, wherein:
the time information input section is supplied with time information from digital broadcasting, and the control section indicates a time based on the time information obtained by the time information input section in case of receiving analog broadcasting.

10. The broadcasting reception system as defined in claim 1, wherein:
the timer section is a crystal-oscillator circuit, or a frequency divider.

11. The broadcasting reception system as defined in claim 8, wherein:
the backup power supply is a secondary cell, or a microcell.

12. A method for indicating a time, comprising:
a step for receiving a transmission signal containing time information; and
a step for updating time information in a timer section based on the time information contained in the transmission signal received, while displaying a message to induce inputting of time information by a user when the transmission signal containing time information is not received

13. The method for indicating a time as defined in claim 12, wherein:
the step for updating time information includes a step for establishing an operation mode allowing to update the time information in the timer section by means of an operation by a user when the transmission signal containing time information is not received

14. The method for indicating a time as defined in claim 12, wherein:
the step for receiving a transmission signal includes a step for receiving satellite digital television broadcasting containing the time information as the transmission signal.

15. The method for indicating a time as defined in claim 13, wherein:
the step for receiving a transmission signal includes a step for receiving satellite digital television broadcasting containing the time information as the transmission signal.

16. The method for indicating a time as defined in claim 12, wherein:
the step for receiving a transmission signal includes a step for obtaining the time information from a plurality of transmission sources each of which transmits the time information being the newest time information in accordance with a predetermined order of precedence.

17. The method for indicating a time as defined in claim 13, wherein:
the step for receiving a transmission signal includes a step for obtaining the time information from a plurality of transmission sources each of which transmits the time information being the newest time information in accordance with a predetermined order of precedence.

18. The method for indicating a time as defined in claim 15, wherein:
the predetermined order of precedence is an order of digital broadcasting, a network, and an operation by a user.
